(19) United States
(12) Patent Application Publication
(10) Pub. No.: US 2007/0113065 A1
(43) Pub. Date: May 17, 2007

(54) System and method for recording BIOS programs

(75) Inventors: Chun-Liang Lee, Taipei (TW); Meng-Mu Yang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/387,213

(22) Filed: Mar. 22, 2006

(30) Foreign Application Priority Data
Nov. 14, 2005 (TW) 094139854

(51) Int. Cl. G06F 15/177

(52) U.S. Cl. 713/1

(57) ABSTRACT

A system and method for recording BIOS programs is proposed, which allows a data processing device to be booted by a BIOS program stored in a first memory via a control module, and when a detecting module detects that a BIOS program is not stored in a second memory, records the BIOS program stored in the first memory into the second memory via a recording module, thereafter switches the data processing device from the first memory to the second memory, so that the BIOS program stored in the second memory can be subsequently used for booting the data processing device.

### FIELD OF THE INVENTION

The present invention relates to a system and method for recording Basic Input/Output System (BIOS) programs, and more particularly, to a system and method for recording a BIOS program on a TSOP ROM without the need for a socket.

### BACKGROUND OF THE INVENTION

In today's world, data processing devices with diverse functionalities such as Personal Computers (PCs), Personal Digital Assistants (PDAs), and network servers are being used in various fields. Most of the data processing devices are startup via a Basic Input/Output System (BIOS).

BIOS is developed by product manufacturers before they are sold to the customers. When a BIOS program is developed, system engineers has to write the BIOS program into a memory (e.g. ROM), then assemble the memory stored with the BIOS program therein to a motherboard of the data processing device for debugging. According to the debugging result, the BIOS may be modified or updated, or even rewritten into the memory if it is damaged due to fatal operations.

To facilitate the update and modification of BIOS programs, a socket is often used in conjunction with the memory recorded with the BIOS program by product manufactures. During product development stage, the socket is soldered to a motherboard in advance, and then the memory chip recorded with the BIOS program is attached to the socket before it can be debugged. If the BIOS program requires modification or update, the memory chip has to be released from the socket so that a programmer or other update tools can be used to update or modify the BIOS program recorded in the memory chip.

However, in order to conform to the trend of miniaturization, memory chips nowadays often adopt the Thin Small Outline Package (TSOP) technique for packaging. Since the size of a TSOP package is very small, pins around the chips are densely arranged (usually have at least 32 pins). If the memory chip is frequently plugged and unplugged to/from the socket, the pins around the memory chip may be damaged, shorted and/or even render the memory chip unusable. Moreover, sockets that accommodate to the TSOP package are expensive and cannot be easily maintained, which increase product development cost.

Thus, there is a need for a mechanism that updates BIOS programs without the need of sockets and avoids the above described shortcomings of the prior art.

### SUMMARY OF THE INVENTION

In the light of forgoing drawbacks, an objective of the present invention is to provide a system and method for recording BIOS programs without using sockets for attaching memory chips stored with BIOS programs to a motherboard, which reduces cost.

Another objective of the present invention is to provide a system and method for recording BIOS programs that enhances design flexibility.

In accordance with the above and other objectives, the present invention provides a system for recording Basic Input/Output System (BIOS) programs applicable in a data processing device. The system for recording BIOS programs comprises: a first memory stored with a BIOS program; at least one second memory; a control module for enabling one of the first memory and the second memory; a detecting module for detecting whether a BIOS program is stored in the second memory and generating a recording signal when no BIOS program is stored in the second memory; and a recording module for recording the BIOS program stored in the first memory into the second memory upon receiving the recording signal from the detecting module. After the recording is completed, the recording module generates a control signal to the control module to disable the first memory and enable the second memory, such that the BIOS program recorded in the second memory is subsequently used for booting the data processing device.

In one embodiment, if the detecting module detects a BIOS program is stored in the second memory, a query is outputted to inquire users whether to overwrite the BIOS program already stored in the second memory, if the users choose to overwrite, then the detecting module generates the recording signal to the recording module; else, the BIOS program in the second memory is retained.

In one embodiment, the control module comprises: a select signal generating module for generating a first select signal and at least one second select signal corresponding to the first and the at least one second memory, respectively; a switch signal generating module for generating a switch signal for switching between the first and the second select signals; and a switching module for receiving the first and the second select signals and the switch signals and outputting one of the first and second select signals based on the switch signal to enable the corresponding one of the first memory and second memory.

In one embodiment, the first memory may be a memory packaged using a Plastic Loaded Chip Carrier (PLCC) packaging technique.

In another embodiment, the first memory may be a flash memory stick.

In one embodiment, the second memory may be a memory packaged using a This Small Outline Package (TSOP) technique.

The present invention also provides a method for recording BIOS programs in a data processing device. The method comprises: storing a BIOS program into a first memory; enabling the first memory to allow the BIOS program stored in the first memory to be used for data processing device startup; and detecting whether a BIOS program is stored in a second memory, if not, recording the BIOS program stored in the first memory into the second memory.

After the recording, the method further enables the second memory and disables the first memory so as to switch the data processing device from the first memory to the second memory, such that the BIOS program recorded in the second memory is subsequently used in startup of the data processing device.

In one embodiment, in the step of detecting whether a BIOS program is stored in a second memory, if a BIOS program is detected to be stored in the second memory, then a query is outputted to users to inquire whether to overwrite the BIOS program in the second memory with the first memory, if so, then recording the BIOS program stored in the first memory into the second memory.

The present invention allows a BIOS program to be recorded in the second memory (or updated) without the need to plug/unplug the second memory in the TSOP packaging from the motherboard of the data processing device, thus preventing the pins of the TSOP memory from damage due to frequent plugging/unplugging. Moreover, there is no need for the more expensive socket of the TSOP memory, thus the present invention further reduces cost.

In addition, the present inventions pre-records a BIOS program in the first memory, such as in a PLCC package or a flash memory, such that the BIOS program in the first memory can be recorded in the TSOP memory, or even the BIOS program in the TSOP memory can be updated (or overwritten) via the BIOS program in the first memory, thereby providing greater design flexibility.

### BRIEF DESCRIPTION OF THE DRAWINGS

The present invention can be more fully understood by reading the following detailed description of the preferred embodiments, with reference made to the accompanying drawings, wherein:

FIG. 1 shows a block diagram illustrating the basic structure of a BIOS recording system of the present invention;

FIG. 2 illustrates connections between a switching module and a first memory and two second memories in the BIOS recording system of FIG. 1;

FIG. 3 shows a flowchart of a BIOS recording method of the present invention; and

FIG. 4 shows another embodiment of the BIOS recording method of the present invention

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

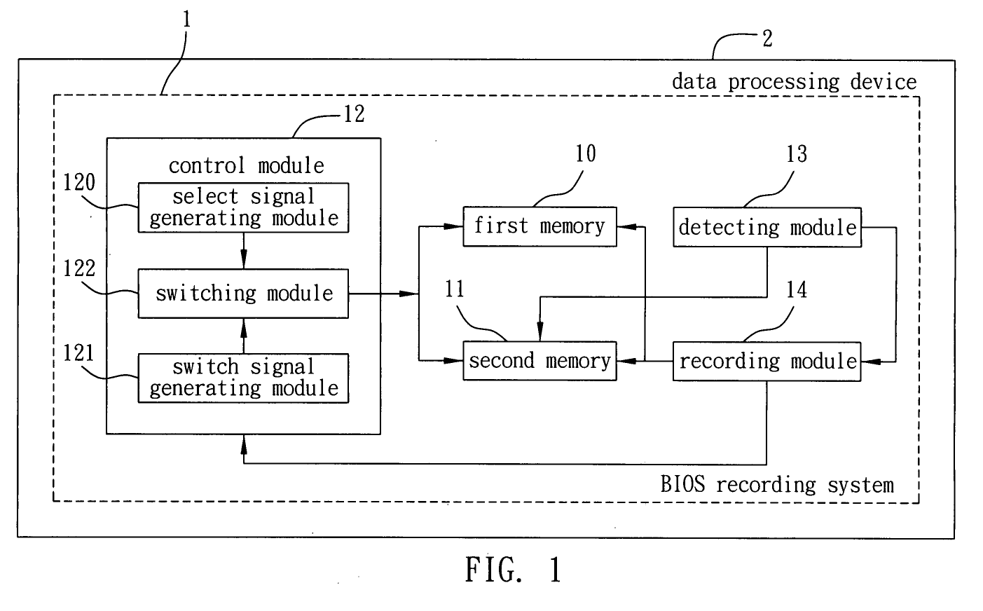

Please refer now to FIG. 1, shown is a block diagram illustrating the basic structure of a BIOS recording system 1 of the present invention. As shown, the BIOS recording system 1 is applied in a data processing device 2. The data processing device is, for example, a server or a computer etc.

As shown in FIG. 1, the BIOS recording system 1 comprises: a first memory 10, at least one second memory 11, a control module 12, a detecting module 13 and a recording module 14. The details of the BIOS recording system 1 of the present invention will now be described.

The first memory 10 is used o store the BIOS program to be recorded. In the present invention, the first memory 10 is a memory packaged using a Plastic Loaded Chip Carrier (PLCC) packaging technique, such as a PLCC ROM. Alternatively, the first memory can be other types of memory depending on different applications, such as a flash memory stick. The first memory of the present invention is not limited to a memory in the PLCC package.

The second memory 11 is the memory to which the BIOS program is to be recorded. In the present invention, the second memory 11 is a memory packaged using the TSOP packaging technique, such as a TSOP ROM.

The control module 12 is used to control the data processing device 2, so that at startup the BIOS program stored in the first memory 10 is used to complete the startup routines.

The detecting module 13 is used to actuate the second memory 11 to be in an enabled state after the data processing device 2 has successfully startup, and detect if a BIOS program of the data processing device 2 is stored in the second memory 11. If it is determined that the second memory 11 does not store the BIOS program, then the detecting module 13 generates a recording signal output.

The recording module 14 is used to record the BIOS program stored in the first memory 10 into the second memory 11, and generates a control signal when the recording process is completed, such that the control module 12 switches the data processing device 2 from the first memory 10 to the second memory 11 based on the control signal, so when the data processing device 2 is rebooted, the BIOS program stored in the second memory 11 is used to complete the startup routines.

Moreover, in another embodiment of the BIOS recording system 1 of the present invention, the control module can further comprise a select signal generating module 120, a switch signal generating module 121 and a switching module 122. The control module is now described in details.

The select signal generating module 120 is sued to generate at least a first select signal CS0 and a second select signal CS1, which correspond to the first memory 10 and the second memory 11, respectively.

The switch signal generating module 121 is used to generate a switch signal so as to switch between the first select signal CS0 and a second select signal CS1. In the present invention, the switch signal generating module 12 may generate the switch signal based on an instruction input to the data processing device 2 in advance by a user (e.g. a product development engineer).

The switching module 122 is used to receive the first select signal, the second select signal and the switch signal from the select signal generating module 120 and the switch signal generating module 121. The switching module 122 can for example be a MUX or other equivalent circuits depending on different applications. In one embodiment, when the switch signal is not asserted, the switching module 122 outputs the first select signal CS0 so as to enable the first memory 10, such that the data processing device 2 can be startup using the BIOS program stored in the first memory 10; when the switch signal is asserted, the switching module 122 outputs the second select signal CS1 so as to enable the second memory 10, such that the data processing device 2 can be startup using the BIOS program stored in the second memory 10. In another embodiment, the conditions of switching with respect to the assertion of the switch signal may be reversed. That is, if the switch signal is not asserted, then the switching module 122 outputs the second select signal CS1 instead; and if the switch signal is asserted, then the switching module 122 outputs the first select signal CS0.

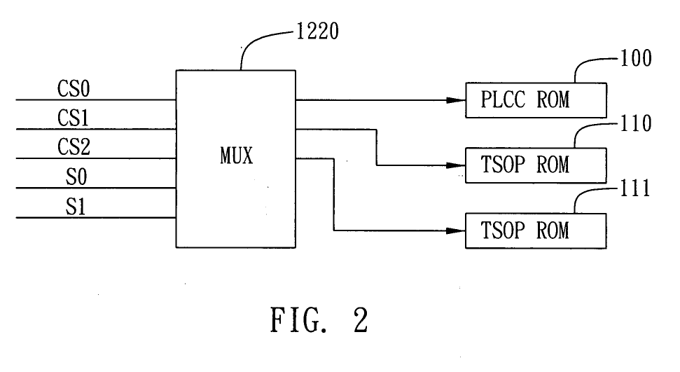

To further illustrate the principles and effects of the present invention, FIG. 2 illustrates connections between the switching module 122 and a first memory and two second memories as an example. In FIG. 2, the first memory is a PLCC ROM 100, and the two second memories are TSOP ROM 110 and TSOP ROM 111, respectively. The switching module is embodied as a MUX 1220. Further, the select signal generating module 120 generates a first, a second and a third select signal CS0, CS1, and CS2 corresponding to the PLCC ROM 100, the TSOP ROM 110 and the TSOP ROM 111, respectively; the switch signal generating module 121 generates a first switch signal S0 and a second switch signal S1, which are both digital binary signals.

As shown in FIG. 2, the MUX 1220 is provided in a motherboard (not shown) of the data processing device 2. The first, second and third select signals CS0, CS1 and CS2 are input to the input terminals of the MUX 1220. The digital switch signals S0, S1 are input to the control terminals of the MUX 1220. Three output terminals of the MUX 1220 are respectively connected to the enable terminals of the PLCC ROM 100, the TSOP ROM 110 and the TSOP ROM 111. The TSOP ROM 110 and the TSOP ROM 111 are directly soldered on the motherboard of the data processing device 2, and the PLCC ROM 100 is attached to the motherboard via a socket (not shown), so the PLCC ROM 100 is detachable from motherboard.

In one embodiment, three combinational logics “00”, “01”, “10” of the digital switch signals S0, S1 are used, and these combinational logical values may correspond to the first, second and third select signals output by the MUX 1220 in a manner shown in table 1 below:

TABLE 1

| (S0 [symbol] S1) value | Output |
|---|---|
| 0 0 | CS0 |
| 0 1 | CS1 |
| 1 0 | CS2 |

It should be noted that different combinations of logical values may be used for the select signals in other embodiments of the present invention. In this embodiment, when the data processing device 2 is startup, the BIOS recording system 1 of the present invention may generate a set of logic values “00” as switch signals to be input to the control terminals of the MUX 1220, then the MUX 1220 outputs the select signal CS0 corresponding to the switch signal inputs “00” to enable the PLCC ROM 100 so it electrically connects to the data processing device 2. As a result, the data processing device 2 is startup by using the BIOS program stored in the PLCC ROM 100. Then, the BIOS recording system 1 actuates and detects whether a BIOS program is stored in the TSOP ROM 110 and TSOP ROM 111. If it is determined that a BIOS program is not stored in the TSOP ROM 110 or the TSOP ROM 111, then the recording process is performed to record the BIOS program stored in the PLCC ROM 110 to the TSOP ROM 110 and/or the TSOP ROM 111. After recording has completed, the BIOS recording system 1 may change the logical values of the switch signals S0, S1 outputted by the switch signal generating module 121 from “00” to “01” or “10” so that the data processing device 2 switches from the PLCC ROM 100 to one of the TSOP ROM 110 and the TSOP ROM 111, so that the BIOS program stored in the TSOP ROM 110 or the TSOP ROM 111 is used next time the data processing device 2 is booted.

In the present invention, when the recording process is completed, the PLCC ROM 100 is detached from the socket. When the BIOS programs in the TSOP ROMs 110, 111 need update, the new BIOS program can be first written into the PLCC ROM 100, then the PLCC ROM 100 is attached to the socket on the motherboard to update the BIOS programs of the TSOP ROMs 110, 111. Similarly, if the BIOS programs in the TSOP ROM 110, 111 are damaged, they can be repaired in the above manner. This provides users, especially product development engineers, greater design flexibility.

Additionally, in the present invention, users may also set the values of the switch signals S0, S1 after the recording process is completed to select one of the TSOP ROM 110, 111 to be connected with the data processing device 2 for startup or update/repair.

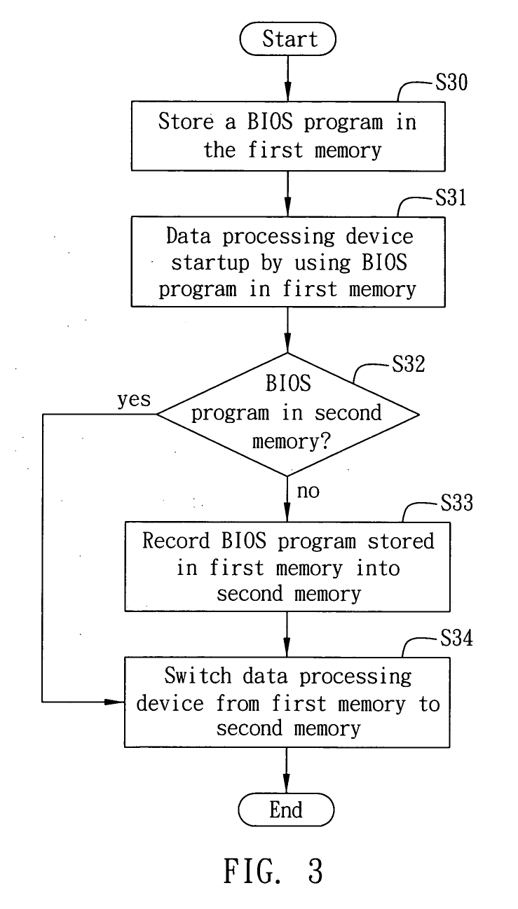

The BIOS recording method executed by the BIOS recording system 1 of the present invention is shown in FIG. 3. The method comprises the following steps: In step S30, the first memory 10 is stored with a BIOS program to be recorded. Next, step S31 is performed.

In step S31, the control module 12 enables the first memory 10 when the data processing device 2 is startup, so as to connect the first memory 10 with the data processing device 2, allowing the BIOS program stored in the first memory 10 to complete the startup routines for the data processing device 2. Step S32 is then performed.

In step S32, the detecting module 13 actuates the second memory 11 such that it is in an enabled state, and detects whether a BIOS program is stored in the second memory 11, if so, then S34 is performed; else step S33 is performed.

In step S33, the recording module 14 records the BIOS program stored in the first memory 10 to the second memory 11. Then, step S34 is performed.

In step S34, the control module 12 switches the data processing device 2 from the first memory 10 to the second memory 11, allowing the data processing device to be turned on by the BIOS program stored in the second memory 11 when rebooted.

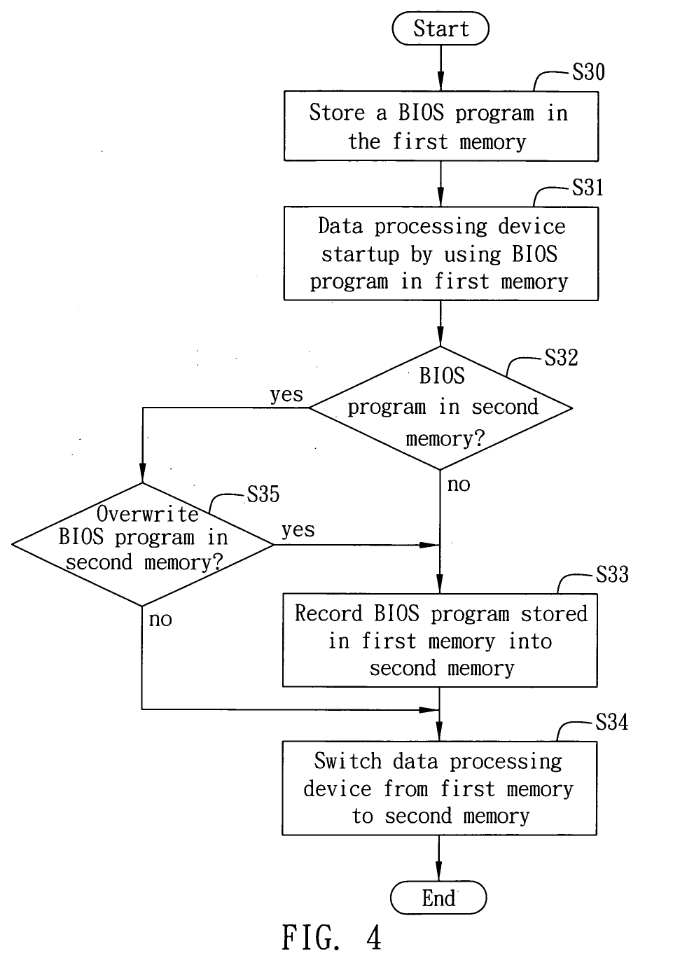

Additionally, FIG. 4 shows another embodiment of the BIOS recording method of the present invention, wherein all steps are the same except for a step S35. Thus, operations same as those described above will be omitted. In step S35, since that a BIOS program is stored in the second memory 11, a display (not shown) of the data processing device 2 will displays a message querying the user whether to overwrite the original BIOS program in the second memory 10 with the BIOS program of the first memory 11, if a request to overwrite is received, then step S33 is repeated; else if a request to retain the original BIOS program is received, then step S34 is repeated.

In summary, the system and method for recording BIOS programs of the present invention applicable in a data processing device allows the data processing device to be booted by the BIOS program stored in the first memory via the control module, and when the detecting module detects that a BIOS program is not stored in a second memory, records the BIOS program stored in the first memory into the second memory via the recording module, thereafter switches the data processing device from the first memory to the second memory, so that the BIOS program stored in the second memory can be subsequently used for booting the data processing device.

The present invention allows a BIOS program to be recorded in the second memory (or updated) without the need to plug/unplug the second memory in the TSOP packaging from the motherboard of the data processing device, thus preventing the pins of the TSOP memory from damage due to frequent plugging/unplugging. Moreover, there is no need for the more expensive socket of the TSOP memory, thus the present invention further reduces cost.

In addition, the present inventions pre-records a BIOS program in the first memory, such as in a PLCC package or a flash memory, such that the BIOS program in the first memory can be recorded in the TSOP memory, or even the BIOS program in the TSOP memory can be updated (or overwritten) via the BIOS program in the first memory, thereby providing greater design flexibility.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A system for recording Basic Input/Output System (BIOS) programs applicable in a data processing device, comprising:
a first memory stored with a BIOS program;
at least one second memory;
a control module for enabling one of the first memory and the second memory;
a detecting module for detecting whether a BIOS program is stored in the second memory and generating a recording signal when no BIOS program is stored in the second memory; and
a recording module for recording the BIOS program stored in the first memory into the second memory upon receiving the recording signal from the detecting module.

2. The system for recording BIOS programs of claim 1, wherein after the recording is completed, the recording module generates a control signal to the control module to disable the first memory and enable the second memory, such that the BIOS program recorded in the second memory is subsequently used for booting the data processing device.

3. The system for recording BIOS programs of claim 1, wherein if the detecting module detects a BIOS program is stored in the second memory, a query is outputted to inquire users whether to overwrite the BIOS program already stored in the second memory, if the users choose to overwrite, then the detecting module generates the recording signal to the recording module.

4. The system for recording BIOS programs of claim 1, wherein the control module comprises:
a select signal generating module for generating a first select signal and at least one second select signal corresponding to the first and the at least one second memory, respectively;
a switch signal generating module for generating a switch signal for switching between the first and the second select signals; and
a switching module for receiving the first and the second select signals and the switch signals and outputting one of the first and second select signals based on the switch signal to enable the corresponding one of the first memory and second memory.

5. The system for recording BIOS programs of claim 1, wherein the first memory is a memory packaged using a Plastic Loaded Chip Carrier (PLCC) packaging technique.

6. The system for recording BIOS programs of claim 1, wherein the first memory is a flash memory stick.

7. The system for recording BIOS programs of claim 1, wherein the second memory is a memory packaged using a This Small Outline Package (TSOP) technique.

8. A method for recording BIOS programs in a data processing device, comprising:
storing a BIOS program into a first memory;
enabling the first memory to allow the BIOS program stored in the first memory to be used for data processing device startup; and
detecting whether a BIOS program is stored in a second memory, if not, recording the BIOS program stored in the first memory into the second memory.

9. The method for recording BIOS programs of claim 8, further comprising, after the recording, enabling the second memory and disabling the first memory so as to switch the data processing device from the first memory to the second memory, such that the BIOS program recorded in the second memory is subsequently used in startup of the data processing device.

10. The method for recording BIOS programs of claim 8, wherein in the step of detecting whether a BIOS program is stored in a second memory, if a BIOS program is detected to be stored in the second memory, then a query is outputted to users to inquire whether to overwrite the BIOS program in the second memory with the first memory, if so, then recording the BIOS program stored in the first memory into the second memory.

11. The method for recording BIOS programs of claim 8, wherein the first memory is a memory packaged using a Plastic Loaded Chip Carrier (PLCC) packaging technique.

12. The method for recording BIOS programs of claim 8, wherein the first memory is a flash memory stick

13. The method for recording BIOS programs of claim 8, wherein the second memory is a memory packaged using a This Small Outline Package (TSOP) technique
